(19) United States
(12) Patent Application Publication
(10) Pub. No.: US 2026/0273519 A1
(43) Pub. Date: Sep. 17, 2026

(54) SEPARATION AND PURIFICATION OF CHEMICALS USING ION-EXCHANGE RESINS

(71) Applicant: Materials Engineering and Technical Support Services, Westerville, OH (US)

(72) Inventors: Matthew Nilsen, Columbus, OH (US); Kelsey Turner, Westerville, OH (US); Adriane Lewis, Columbus, OH (US); Daniel Badowski, Westerville, OH (US); Kenneth Heater, Delaware, OH (US); Bethany Schneider, Westerville, OH (US)

(73) Assignee: Materials Engineering and Technical Support Services, Westerville, OH (US)

(21) Appl. No.: 19/566,450

(22) Filed: Mar. 13, 2026

Related U.S. Application Data
(60) Provisional application No. 63/771,177, filed on Mar. 13, 2025.

(51) Int. Cl. B01J 39/05; B01J 20/08; B01J 47/02

(52) U.S. Cl. CPC B01J 39/05; B01J 20/08; B01J 47/02; B01J 2220/42

(57) ABSTRACT

Systems and methods for separation and purification of chemicals using ion-exchange resins are provided.

### CROSS-REFERENCE TO RELATED APPLICATIONS

This application claims priority from U.S. Provisional Patent Application No. 63/771,177, filed on Mar. 13, 2025, which is incorporated by reference herein in its entirety.

### BACKGROUND

Recovery and purification of organic products from waste and process streams can be challenging. Examples include recovery and purification of essential oils, medicinal products, THC/CBD, nicotine, and the like, as well as the purification and recycling of industrial chemicals.

As just one example, electronic cigarettes are battery-powered, tobacco-free nicotine delivery devices. The devices aerosolize a nicotine-containing solution known as an “e-liquid” without combustion or smoke. E-liquids can contain humectants (propylene glycol or glycerol or both), flavorings, nicotine, and other additives in varying amounts.

E-cigarettes and other nicotine-containing products present a complex type of waste in the environment. Due to the presence of nicotine in e-liquids and other nicotine-containing products, these products cannot be readily disposed of because nicotine is defined by the Environmental Protection Agency as an acute hazardous waste.

Considering that levels of e-cigarette and other nicotine-containing product use are on the rise, there is a need to prevent nicotine contamination of landfills, waterways, fields, landscapes, and other environmental domains where the environment or human or animal health can be harmed. Previous studies have focused on nicotine extraction from tobacco products for use in e-cigarettes as well as extracting nicotine from e-liquids and other nicotine-containing products for the purpose of quantifying nicotine concentration in various types of e-cigarettes. However, few, if any, systems and methods exist to remove nicotine from e-liquids to de-toxify e-liquid waste and obtain pure nicotine product.

### SUMMARY

Systems and methods to recover and purify products from liquid media are provided. In a non-limiting example, the systems and methods are used to remove nicotine from a sample of e-liquid. The e-liquid sample may be obtained from electronic cigarettes, vapes, and other devices used for nicotine delivery to a user. In one aspect, the systems and methods are characterized in that the nicotine product is at least 98% pure. In another aspect, the e-liquid waste product is rendered non-toxic.

### BRIEF DESCRIPTION OF THE FIGURES

The present invention may be more readily understood by reference to the following figures, wherein:

FIG. 1A is a diagram depicting an example configuration of an extraction and purification system 100A comprising a first column (“C1”) comprising a strong acid cation resin (e.g., Amberlite FPC88 H resin) and a second column (“C2”) comprising activated basic aluminum oxide.

FIG. 1B is a diagram depicting extraction system 100B, which is an alternative configuration to extraction and purification system 100A, omitting the activated basic aluminum oxide column C2.

FIG. 2 is a diagram depicting the configuration of a purification and isolation system 200 comprising a column (“C3”) comprising a strong acid cation resin for use with an extraction system such as 100A or 100B.

FIG. 3 is a diagram depicting the configuration of system 300 for using ion-exchange resins to separate potassium formate from ethylene glycol.

### DETAILED DESCRIPTION

### Definitions

The term “about” in conjunction with a number is intended to include ±10% of the number. This is true whether “about” is modifying a stand-alone number or modifying a number at either or both ends of a range of numbers. In other words, “about 10” means from 9 to 11. Likewise, “about 10 to about 20” contemplates 9 to 22 and 11 to 18.

The singular forms “a,” “an,” and “the” include plural referents unless the context clearly dictates otherwise.

Where a range of values is provided, each intervening value, to the tenth of the unit of the lower limit unless the context clearly dictates otherwise, between the upper and lower limit of that range, and any other stated or intervening value in that stated range, is encompassed. The upper and lower limits of these smaller ranges may independently be included in the smaller ranges and are also encompassed, subject to any specifically excluded limit in the stated range. Where the stated range includes one or both of the limits, ranges excluding either or both of those included limits are also included.

When used in a list, the term “or” is intended to be interpreted as inclusive, unless explicitly stated otherwise, e.g., as in “A or B, but not both.”

Unless defined otherwise, all technical and scientific terms have the same meaning as commonly understood by one of ordinary skill in the art to which this invention belongs.

### Extraction Process

In one aspect, a method for separation and purification of chemicals using ion-exchange resins is provided. In one example aspect, the method is a nicotine extraction process comprising extracting nicotine from an e-liquid. In one aspect, the process further comprises purifying the extracted nicotine. In another aspect, the process further comprises isolating the purified nicotine.

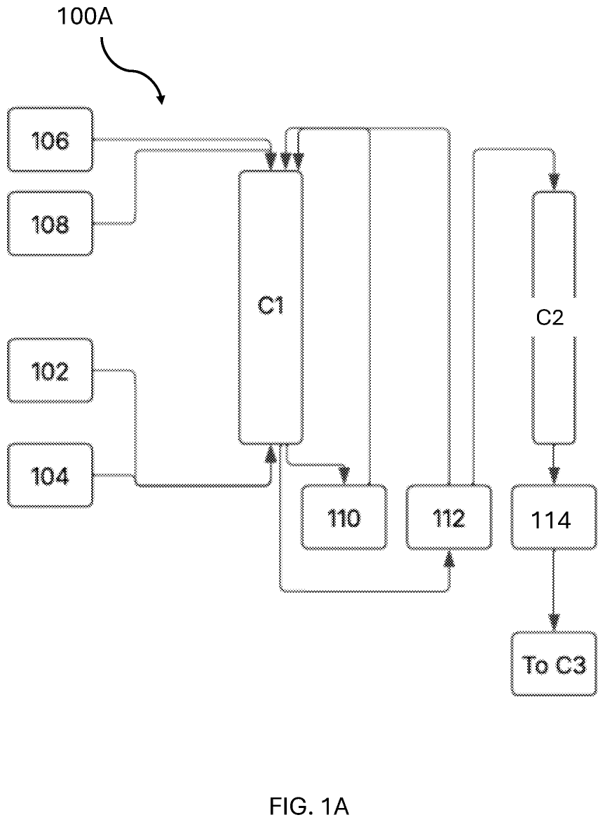

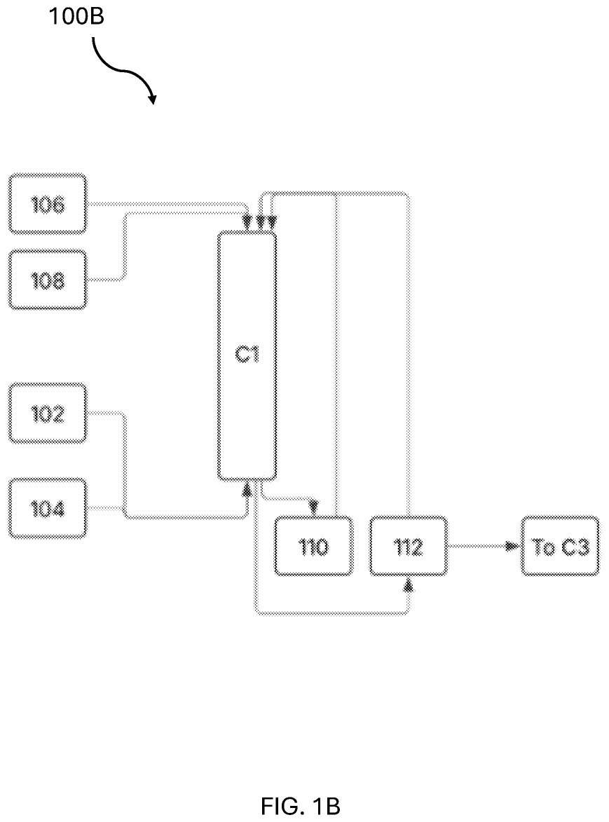

Referring to FIG. 1A, in one aspect, the extracting comprises: an e-liquid fill step, wherein the e-liquid is passed from an e-liquid source 102 through system 100A into C1 from the bottom to the top; a water rinse step, wherein fresh DI water is run from a water source 104 through system 100A into C1 from the bottom to the top; a heptane rinse step, wherein fresh heptane is run from a heptane source 106 through system 100A into C1 from the top to the bottom into a mixed solvent waste drum 110; an elution step, wherein diluted diethylamine (DEA) in heptane is prepared and then run from a DEA in heptane (e.g., ~1M to 2M concentration) source 108 through system 100A into C1 from the top to the bottom into a recirculation drum 112; a second heptane rinse step, wherein heptane is run from mixed solvent waste drum 110 through system 100A into C1 from the top to the bottom into recirculation drum 112 to produce a heptane layer and a glycol layer in recirculation drum 112; and a recirculation step, wherein heptane is run from the heptane layer in recirculation drum 112 through system 100A into C1 from the top to the bottom and back into recirculation drum 112 to produce a primary recirculation fluid in recirculation drum 112.

With further reference to FIG. 1A, the purifying comprises: an alumina preparation and rinse step, wherein glass wool is added to the bottom of C2 followed by alumina, and fresh heptane is run from heptane source 106 through system 100A into C2 from the top to the bottom and into intermediate container 114 until the alumina is fully saturated (not shown); a recirculation fluid purification step, wherein the primary recirculation fluid is run from recirculation drum 112 through system 100A into C1 from the top to the bottom and into C2 from the top to the bottom and into an intermediate container 114; a third heptane rinse step, wherein fresh heptane is run from heptane source 106 through system 100A into C1 from the top to the bottom and into recirculation drum 112 to form a secondary recirculation fluid solution in recirculation drum 112; and a C2 heptane rinse step, wherein the secondary recirculation fluid is run from recirculation drum 112 through system 100A into C2 from the top to the bottom into intermediate container 114.

In an alternative aspect, shown in FIG. 1B, nicotine-containing e-liquid is filtered through, e.g., a 25 um filter, prior to processing. The viscosity of the filtered e-liquid material is measured, and water is mixed into solution, if necessary, to achieve a maximum viscosity of, e.g., 14 cP. E-liquid material is passed from e-liquid source 102 through system 100B through C1 from bottom-to-top, capturing the nicotine in solution. Non-hazardous e-liquid components are rinsed out of C1 with deionized water (from water source 104), then rinsed with acetone as a co-solvent. Heptane from heptane source 106 is passed through C1 in a top-to-bottom configuration. A solution of ~1M diethylamine in heptane from a DEA in heptane (e.g., ~1M to 2M concentration) source 108 is passed top-to-bottom through C1 into recirculation drum 112 to elute the nicotine from the resin beads.

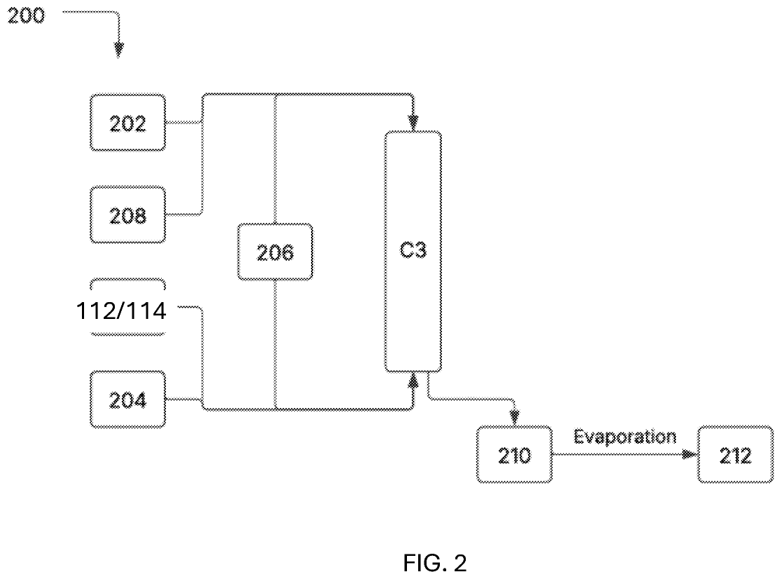

Referring to FIG. 2, in one aspect, the isolating may comprise: a heptane rinse step, wherein fresh heptane is run from heptane source 202 through system 200 into C3 from the top to the bottom; a nicotine in heptane step, wherein the nicotine in heptane solution is run from recirculation drum 112 or intermediate container 114 through system 200 into C3 from the bottom to the top; an acetone rinse step, wherein fresh acetone is run from an acetone source 204 through system 200 into C3 from the bottom to the top; a methanol rinse step, wherein fresh methanol from a methanol source 206 is run through system 200 into C3 from the bottom to the top; an elution step, wherein a solution of ~1M DEA in methanol is run from a DEA in methanol source 208 through system 200 into C3 from the top to the bottom into a nicotine in methanol solution drum 210; and a second methanol rinse step, wherein fresh methanol is run from methanol source 206 through system 200 into C3 from the top to the bottom into nicotine in methanol solution drum 210; and evaporating the methanol solvent from the nicotine in methanol solution to produce a pure, isolated nicotine product 212.

In one aspect, not shown, the strong acid cationic resin columns may be regenerated, the regeneration process comprising: a C3 regeneration step, wherein 7%/wt H₂SO₄ is run through system 200 into C3 from the bottom to the top; a conductivity measurement step, wherein the conductivity of the waste stream is measured and ensured to be above 199 mS; a C3 water rinse step, wherein fresh water from a water source is run through system 200 into C3 from the bottom to the top; a C3 methanol rinse step, wherein fresh methanol is run from methanol source 206 through system 200 into C3 from the bottom to the top; a C1 water rinse step, wherein fresh water is run from a water source through system 100A or 100B into C1 from the bottom to the top; a C1 regeneration step, wherein fresh 7%/wt H₂SO₄ is run through the system into C1 from the bottom to the top until the waste stream has a conductivity greater than 199 mS; and a C1 final rinse step, wherein fresh water is run from a water source through system 100 through C1 from the bottom to the top until the conductivity of the waste stream is lower than 1000 mS.

In an additional aspect, pure nicotine product 212 is packaged, e.g., by drawing the nicotine product into a clean syringe and transferring the nicotine product into the appropriate storage container.

### Nicotine Extraction System

In one aspect, a system for the extraction of nicotine from a waste e-liquid is provided, the system comprising: an e-liquid source comprising a sample of waste e-liquid; solvent drums; and extraction and purification columns.

In one aspect, the extraction column comprises a strong acid cationic resin. In one aspect, the purification columns comprise activated basic aluminum oxide and, in a separate column, a strong acid cationic resin.

In one aspect, the solvent drums comprise: a heptane drum containing heptane; a diluted DEA in heptane drum containing diluted DEA in heptane; an acetone drum containing fresh acetone; a methanol drum containing fresh methanol; a methanol solvent drum for solvent recovery; and a diluted DEA in methanol drum containing diluted DEA in methanol.

Chemical Separation-Ionic/Organic Mixture

In another example of using ion-exchange resins to separate chemicals, a process was developed using ion-exchange resins to separate potassium formate from ethylene glycol. Cross-contamination of heat exchanger fluids, e.g., potassium formate and ethylene glycol, can reduce equipment functionality and damage equipment, leading to increased system maintenance, and requiring partial or complete replacement of the heat exchanger fluids. The use of ion exchange resins provides multiple advantages compared to wet chemistry approaches, most notably the complete removal of all contaminants.

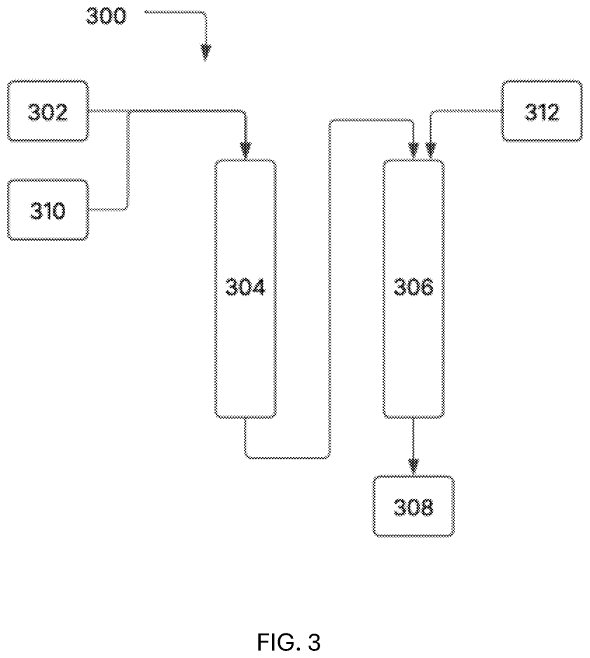

Referring to FIG. 3, contaminated glycol 302 is added to a strong acid ion exchange bed (e.g., Monosphere 88 resin) 304 to convert the potassium formate into formic acid. Formic acid is removed on a second ion exchange bed 306 containing a strongly basic resin (e.g., Amberlyst FPA 22) to yield purified glycol 308. The process removes about 96% of potassium formate from a contaminated sample of ethylene glycol (5%/v) at a process flow rate of 2.4 gallons per hour. After use, both resin beds can be regenerated using weak acid and base solutions (a 2% sulfuric acid 310 solution for the strongly acidic column 304 and a 2% sodium hydroxide solution 312 for the strongly basic column 306) respectively, which are the only sources of process materials requiring disposal (disposal outlets not shown). A glycol purification system was designed and demonstrated, effectively processing (for example) 86 gallons of ethylene contaminated with 5%/v potassium formate per hour.

1. A method, the method comprising extracting a product from a liquid process sample or waste sample, wherein the extracting comprises: a liquid fill step, wherein the liquid is delivered into a first column (C1) comprising a strong acid cationic resin; a water rinse step, wherein water is passed through C1; a heptane rinse step, wherein heptane is passed through C1; an elution step, wherein diethylamine (DEA) in heptane is passed through C1; a second heptane rinse step, wherein heptane is passed through C1 to form an extracted product solution; and a recirculation step, wherein the extracted product solution is recirculated through C1.

2. The method of claim 1, further comprising purifying and/or isolating the extracted product.

3. The method of claim 2, wherein the purifying comprises: passing the recirculated extracted product solution through a second column (C2) comprising activated basic aluminum oxide; a third heptane rinse step, wherein heptane is passed through C1; and a C2 heptane rinse step, wherein fluid from the third heptane rinse step is through C2 to form a purified product solution.

4. The method of claim 2, wherein the isolating comprises: passing the extracted product solution through a second column (C3) comprising a strong acid cationic resin; an acetone rinse step, wherein acetone is passed through C3; a methanol rinse step, wherein methanol is passed through C3; an elution step, wherein a solution of DEA in methanol is passed through C3; and a second methanol rinse step, wherein methanol is passed through C3 to produce a product in methanol solution; and evaporating the methanol solvent from the product in methanol solution to produce a pure, isolated product.

5. The method of claim 3, wherein the isolating comprises: passing the purified product solution through a third column (C3) comprising a strong acid cationic resin; an acetone rinse step, wherein acetone is passed through C3; a methanol rinse step, wherein methanol is passed through C3; an elution step, wherein a solution of DEA in methanol is passed through C3; and a second methanol rinse step, wherein methanol is passed through C3 to produce a product in methanol solution; and evaporating the methanol solvent from the product in methanol solution to produce a pure, isolated product.

6. The method of claim 1, wherein the product is nicotine, and the process sample or waste sample is a waste e-liquid sample.

7. A system for the extraction of a product from a process sample or waste sample, the system comprising an extraction column comprising a strong acid cationic resin.

8. The system of claim 7, further comprising a purification column comprising activated basic aluminum oxide.

9. The system of claim 7, further comprising a polishing column comprising a strong acid cationic resin.

10. The system of claim 8, further comprising a polishing column comprising a strong acid cationic resin.

11. A method, the method comprising extracting a product or contaminant from a liquid process sample or waste sample, by first converting the product or contaminant to an acid, wherein the product or contaminant is converted to an acid using an ion exchange resin comprising a strong acid resin.

12. The method of claim 11, where the acid form of the product or contaminant is removed by an ion exchange resin comprising a strong base resin.
